(19) United States
(12) Patent Application Publication
(10) Pub. No.: US 2008/0158866 A1
(43) Pub. Date: Jul. 3, 2008

(54) Illuminating Wind-Bell Using Solar Energy

(75) Inventor: Quanwei Fan, Guangzhou (CN)

Correspondence Address: WANG & HO, 66 HILLTOP ROAD, MILLINGTON, NJ, 07946, US

(73) Assignee: GUANGZHOU FAPU ELECTRONIC & TECHNOLOGY CO., LTD., Guangzhou (CN)

(21) Appl. No.: 11/911,199

(22) PCT Filed: Dec. 8, 2005
(86) PCT No.: PCT/CN05/02119

§ 371 Date: Oct. 11, 2007

(30) Foreign Application Priority Data
Oct. 31, 2005 (CN) 200520066360.8

(51) Int. Cl. F21L 4/00

(52) U.S. Cl. 362/191

(57) ABSTRACT

An illuminating wind-bell apparatus using solar energy, which contains a solar collecting and converting unit, an overhead housing, a striker, tubes and light emitting diodes. The striker and the tubes are suspended under the overhead housing. The solar collecting and converting unit is arranged on the overhead housing or separately from the wind-bell apparatus. The light emitting diodes may be located under the overhead housing, under the tubes or in the tubes, and the light emitting diodes may be located under the striker or in the striker. The solar collecting and converting unit is electrically connected to the light emitting diodes and supplies power to the light emitting diodes.

### FIELD OF THE INVENTION

The present invention relates to a wind-bell apparatus. More particularly, it relates to an illuminating wind-bell apparatus.

### BACKGROUND OF THE INVENTION

The existing wind-bell can generally only make sound when the tubes and strikers collide with each other with the help of the wind. Because of the wind-bell's unique characteristic of suspension which is similar to that of pendant lamp in daily life, there comes the concept of “wind-bell lamp.” However, if the wind-bell lamp were using an accumulator, candle, kerosene or low-voltage electrical power source, due to the special location where the bell is hung, it would be very difficult to perform the operations, such as power recharging, ignition, fuel refilling, or managing the long electrical cords. Thus, it would be difficult for the wind-bell lamp to be reduced to practice.

### DESCRIPTION OF THE INVENTION

One object of the present invention is to provide an illuminating wind-bell that employs solar energy, featuring long lighting duration, easy installation, self-contained and sustained without need for manual operation.

The illuminating wind-bell using solar energy according to the present invention comprises an overhead housing, tubes and strikers. The tubes and strikers are suspended under the overhead housing. In addition, there is a solar energy based light emitting device, which comprises a solar collecting and converting unit and light emitting diodes. The light emitting diodes may be located in any places within the wind-bell and the power is supplied through wires from the solar collecting and converting unit.

The solar collecting and converting unit of the present invention may be installed on the overhead housing and supply power to the light emitting diodes through wires. It may also be located separately from the wind-bell and supply power to the light emitting diodes through wires.

The light emitting diodes can be installed under the overhead housing with wire connection. Or, it can be located below or inside the wind-bell tubes with the wires hidden in the tubes. Furthermore, it can be located below or inside the strikers.

The illuminating wind-bell according to the present invention can have one or as many light emitting diodes as desired and they may emit single-color light or multiple-color light.

The overhead housing is the installation base of the illuminating wind-bell. Ropes, chains or hooks may be installed on the top of the overhead housing to suspend the illuminating wind-bell. The wind-bell tubes, strikers and other decorative accessories can be hung by a piece of rope or chain from underneath the overhead housing. The solar collecting and converting unit as well as light emitting diodes may also be installed on the overhead housing.

The solar collecting and converting unit supplies power to the light emitting diodes through built-in electric circuit and wires. It converts the solar energy to electric energy and charges the battery during the daytime, while the photosensitive switch is actuated automatically to enable the light emitting diodes to illuminate during the nighttime.

Compared with the existing wind-bell apparatus, the illuminating wind-bell of the present invention has the following advantageous features.

(1) The existing wind-bell can make the striking sound only with the help of the wind. By contrast, the illuminated wind-bell using solar energy can not only make the sound, but also illuminate and display its aesthetically pleasing appearance to viewers at the night time. By combining “light, sound and electricity,” it is a product particularly suitable for gardens and parks.

(2) The energy for the lighting of the illuminated wind-bell of the present invention comes from a natural source. The light emitting diodes are able to turn on or turn off automatically, which is more adaptive and convenient to operate with low costs and no pollution compared with other lamps using powers such as candles, kerosene, accumulators or other sources.

Detailed explanation will be made based on the attached drawings as well as the specific embodiments of the invention.

### BRIEF DESCRIPTION OF DRAWINGS

FIG. 1 is a structural illustration of a particular embodiment of the present invention.

FIG. 2 is a structural illustration of another particular embodiment of the present invention.

### DETAILED DESCRIPTION OF PARTICULAR EMBODIMENTS

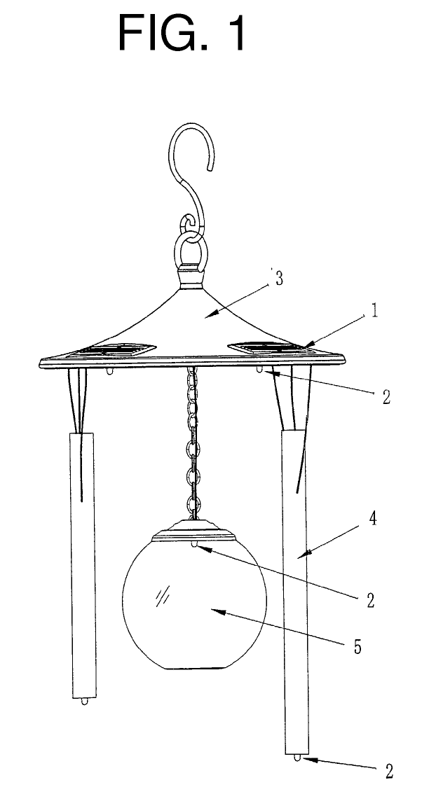

Turing to FIG. 1, which is the structural illustration of a particular embodiment of the present invention, an illuminating wind-bell using solar energy is described therein. The illuminating wind-bell contains a wind-bell that is composed of overhead housing 3, tubes 4 and a striker 5. The tubes 4 and striker 5 are suspended under the overhead housing 3 through a piece of rope or chain. The illuminating wind-bell further contains a light emitting device using solar energy, which comprising a solar collecting and converting unit 1 and light emitting diodes 2. The light emitting diodes 2 may be installed under the overhead housing 3, inside striker 5 and under tubes 4. The solar collecting and converting unit 1 is located on the overhead housing 3 and supplies power to light emitting diodes 2 through electric wire.

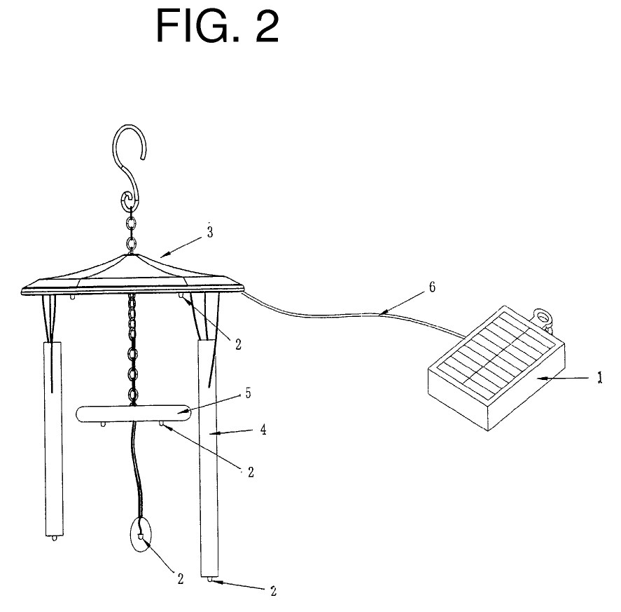

As shown in FIG. 2, which is a structural illustration of another particular embodiment of the present invention, an illuminating wind-bell using solar energy described therein contains a wind-bell that is composed of overhead housing 3, tubes 4 and a striker 5. The tubes 4 and striker 5 are suspended under the overhead housing 3 through a piece of rope or chain. The illuminating wind-bell further contains a light emitting device using solar energy, which comprises solar collecting and converting unit 1 and light emitting diodes 2. The light emitting diodes 2 may be installed under the overhead housing 3, under striker 5, inside the decorative accessories of the striker, and under tubes 4. The solar collecting and converting unit 1 is located separately outside the wind-bell and supplies power to light emitting diodes 2 through electric wires 6.

1-7. (canceled)

8. An illuminating wind-bell using solar energy, comprising an overhead housing, one or more tubes, one or more strikers and a light emitting device, wherein said light emitting device comprises a solar collecting and converting unit and at least one light emitting diode and wherein said solar collecting and converting unit supplies power to said light emitting diode.

9. The illuminating wind-bell using solar energy according to claim 8, wherein said solar collecting and converting unit is installed on said overhead housing.

10. The illuminating wind-bell using solar energy according to claim 8, wherein said solar collecting and converting unit is installed separately from the illuminating wind-bell and supplies power to light emitting diodes through electric wire.

11. The illuminating wind-bell using solar energy according to claim 8, wherein said light emitting diode is installed under the overhead housing.

12. The illuminating wind-bell using solar energy according to claim 9, wherein said light emitting diode is installed under the overhead housing.

13. The illuminating wind-bell using solar energy according to claim 10, wherein said light emitting diode is installed under the overhead housing.

14. The illuminating wind-bell using solar energy according to claim 8, wherein said light emitting diode is installed under or inside said tubes with wires being hidden inside the tubes.

15. The illuminating wind-bell using solar energy according to claim 9, wherein said light emitting diode is installed under or inside said tubes with wires being hidden inside the tubes.

16. The illuminating wind-bell using solar energy according to claim 10, wherein said light emitting diode is installed under or inside said tubes with wires being hidden inside the tubes.

17. The illuminating wind-bell using solar energy according to claim 8, wherein said light emitting diode is installed under or inside the striker.

18. The illuminating wind-bell using solar energy according to claim 9, wherein said light emitting diode is installed under or inside the striker.

19. The illuminating wind-bell using solar energy according to claim 10, wherein said light emitting diode is installed under or inside the striker.

20. The illuminating wind-bell using solar energy according to claim 8, wherein said light emitting diode is capable of emitting single-color or multi-color light.

21. The illuminating wind-bell using solar energy according to claim 9, wherein said light emitting diode is capable of emitting single-color or multi-color light.

22. The illuminating wind-bell using solar energy according to claim 10, wherein said light emitting diode is capable of emitting single-color or multi-color light.
